(19) United States
(12) Patent Application Publication
(10) Pub. No.: US 2018/0225846 A1
(43) Pub. Date: Aug. 9, 2018

(54) METHOD OF CONVERTING DATA FORMAT

(71) Applicant: Vault Micro, Inc., Seoul (KR)

(72) Inventors: Seong Il KIM, Seoul (KR); Yong Hoon KIM, Osan (KR)

(21) Appl. No.: 15/435,361

(22) Filed: Feb. 17, 2017

(30) Foreign Application Priority Data
Feb. 6, 2017 (KR) 10-2017-0016390

(51) Int. Cl. G06T 11/00; G06T 11/20; G06T 1/60

(52) U.S. Cl. CPC G06T 11/001; G06T 1/60; G06T 11/20

(57) ABSTRACT

Provided is a method of converting data format by which image data may be converted into texture data at high speed in a mobile. The method may include generating a Canvas, a Surface, a SurfaceTexture, and Texture from among objects provided by android system; drawing the image data on the Surface by using a function provided by the Canvas; and when the drawing is completed, converting the data drawn on the Surface into the texture data and storing the converted data in the Texture by using a function provided by the SurfaceTexture.

### CROSS-REFERENCE TO RELATED PATENT APPLICATION

This application claims the benefit of Korean Patent Application No. 10-2017-0016390, filed on Feb. 6, 2017, in the Korean Intellectual Property Office, the disclosure of which is incorporated herein in its entirety by reference.

### BACKGROUND OF THE INVENTION

### 1. Field of the Invention

The present invention relates to a method of converting data format at high speed, and more particularly, to a method of converting image data such as bitmap images into texture data in a mobile at high speed.

### 2. Description of the Related Art

In Android system, hardware acceleration is required to convert or synthesize large image data such as bitmap images at high speed. The Android system supports hardware acceleration through Open Graphic Library for Embedded System (OpenGL ES). In order to control image data such as bitmap images, converting image data into texture-format data (hereinafter, referred to as ‘texture data’) used in the OpenGL ES may be firstly performed.

The Open GL ES is a subset of OpenGL, which is three-dimensional computer graphic Application Program Interface (API) defined by Khronos Group, and is API for embedded terminals such as mobile phones and Personal Digital Assistant (PDA). Starting with OpenGL ES version 1.0/1.1 in android version 1.0, it is expanded that android version 5.0 provides OpenGL ES version 3.1. In OpenGL ES. Various APIs, by which points, lines, and planes in a pixel unit may be drawn, are provided. OpenGL ES provides glTexImage2D as API for converting bitmap images into texture data. Such API is used to convert bitmap images into texture data and the converted data is loaded to a Graphic Processing Unit (GPU) memory. Then, the data may be edited by using various APIs provided in OpenGL ES.

However, glTexImage2D, which is API used to convert image texture provided by OpenGL ES, generally requires about 100ms for converting an image of 720p (1280×720). In 100 ms, only 10 images may be converted per second. When a few large images are generated per second in a camera, for example, additional time needed for image processing such as transforming and synthesizing after converting is required so that data may be hardly processed in real-time.

Also, an Android control provided by Android system allows that image data is drawn on a Canvas and the image is directly displayed on a screen of a user. However, a function of converting image data provided by the android control into texture data is not provided in Android system. Accordingly, in general, in order to convert image data provided by the android control into texture data, the image data is captured to generate a bitmap image and then glTexImage2D is used to convert the bitmap image into texture data. Thus, as described above, when large images are generated, data may be hardly processed in real-time.

### SUMMARY OF THE INVENTION

The present invention provides a method of converting data format by which image data such as bitmap images is converted into texture data in a mobile phone at high speed.

According to an aspect of the present invention, there is provided a method of converting data format by which image data may be converted into texture data at high speed in a mobile. The method may include: generating a Canvas, a Surface, a SurfaceTexture, and Texture from among objects provided by android system; drawing the image data on the Surface by using a function provided by the Canvas; and when the drawing is completed, converting the data drawn on the Surface into the texture data and storing the converted data in the Texture by using a function provided by the SurfaceTexture.

In the drawing, a function provided by the Canvas may be used to draw the image data on the Surface and to store the drawn data in a buffer queue and in the storing in the Texture, a function provided by the SurfaceTexture may be used to convert the data stored in the buffer queue into the texture data and the converted data may be stored in the Texture.

In the drawing, at least one function from among drawArc, drawBitmap, drawCircle, drawColor, drawLine, drawPath, drawPoint, drawRect, drawText provided by the Canvas may be used to draw the image data on the Surface.

The storing in the Texture may include: generating an event, onFrameAvailable, when the drawing is completed; and converting the data drawn on the Surface into the texture data and storing the converted data in the Texture by using a function updateTexImage provided by the SurfaceTexture, when the event, onFrameAvailable, is generated.

In the generating, the Texture, the SurfaceTexture, the Surface, and the Canvas may be sequentially generated.

The generating may include: generating the Texture by using a function glGenTextures provided by Open Graphic Library for Embedded System (OpenGL ES); generating the SurfaceTexture with reference to the generated Texture; generating the Surface with reference to the SurfaceTexture; and returning the Canvas by calling the function lockCanvas from among the functions provided by the Surface.

The Texture may be a space in which the texture data is stored in a GPU memory area.

According to another aspect of the present invention, there is provided a method of converting data format by which image data may be converted into texture data at high speed in a mobile. The method may include: generating a Canvas, a Surface, a SurfaceTexture, and Texture from among objects provided by android system; drawing the image data on the Canvas and the Surface by using a function provided by an android control; and when the drawing is completed, converting the drawn data into the texture data and storing the converted data in the Texture by using a function provided by the SurfaceTexture.

The drawing may include: calling a function provided by the Canvas by using the function provided by the android control; and drawing the image data on the Surface so as to store the drawn data in a buffer queue by using the function provided by the called Canvas, and in the storing in the Texture, a function provided by the SurfaceTexture is used to convert the data stored in the buffer queue into the texture data and the converted data is stored in the Texture.

The drawing may include: calling at least one function from among drawArc, drawBitmap, drawCircle, drawColor, drawLine, drawPath, drawPoint, drawRect, drawText provided by the Canvas by using the function, onDraw, provided by the android control; and drawing the image data on the Surface by using at least one called function from among the functions provided by the Canvas.

The storing in the Texture may include: generating an event, onFrameAvailable, when the drawing is completed; and converting the drawn data into the texture data and storing the converted data in the Texture by using a function updateTexImage provided by the SurfaceTexture, when the event, onFrameAvailable, is generated.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates objects used in a method of converting data format according to an embodiment of the present invention;

FIG. 2 is a flowchart illustrating a method of converting image data into texture data by using the objects of FIG. 1;

FIG. 3 illustrates objects used in a method of converting data format according to another embodiment of the present invention; and

FIG. 4 is a flowchart illustrating a method of converting image data into texture data by using the objects of FIG. 3.

### DETAILED DESCRIPTION OF THE INVENTION

The attached drawings for illustrating exemplary embodiments of the present invention are referred to in order to gain a sufficient understanding of the present invention, the merits thereof, and the objectives accomplished by the implementation of the present invention.

Hereinafter, the present invention will be described in detail by explaining exemplary embodiments of the invention with reference to the attached drawings. Like reference numerals in the drawings denote like elements.

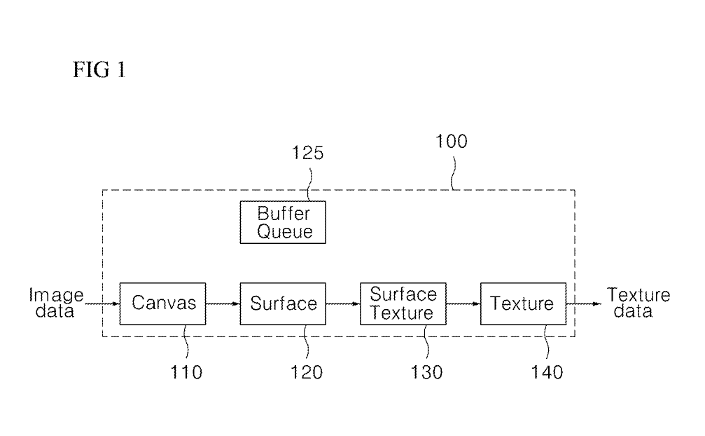

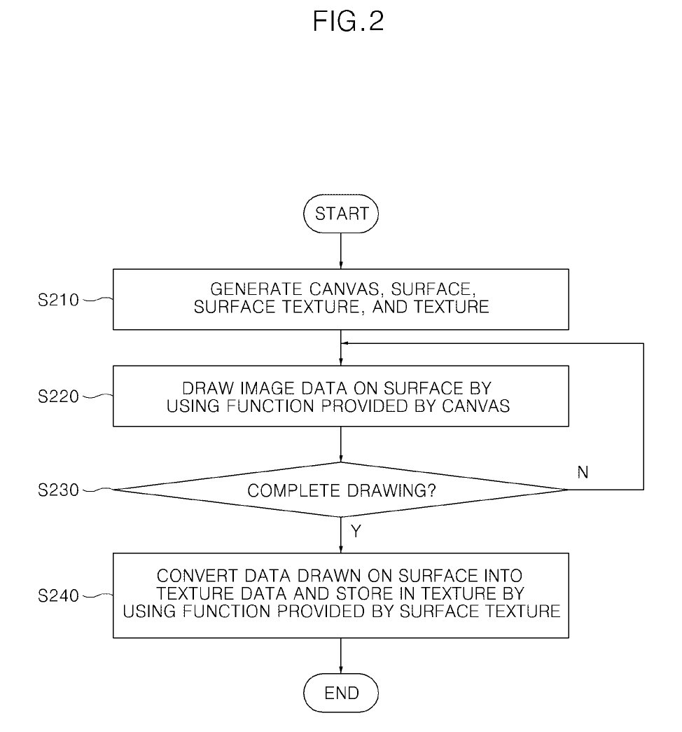

FIG. 1 illustrates objects 100 used in a method of converting data format according to an embodiment of the present invention and FIG. 2 is a flowchart illustrating a method of converting image data into texture data by using the objects 100 of FIG. 1.

Referring to FIGS. 1 and 2, in order to convert image data such as bitmap images into texture data in a mobile at high speed, a Canvas 110, a Surface 120, a SurfaceTexture 130, and a Texture 140 from among objects provided by android system may be used.

The Canvas 110 provides various functions for a drawing work through hardware acceleration. In Canvas 110, various drawing works such as points, lines, circles, and quadrangles may be performed and the bitmap images may be drawn. That is, the functions provided from the Canvas 110 are used to draw image data such as the bitmap images on the Surface 120. At least one function from among drawArc, drawBitmap, drawCircle, drawColor, drawLine, drawPath, drawPoint, drawRect, and drawText provided from the Canvas 110 is used to draw the image data on the Surface 120. For example, a function, drawBitmap is used to draw the bitmap image on the Surface by using an address of the bitmap image stored in a memory. As another example, when a line is to be added while drawing the image data on the Surface 120, a function drawLine may be used. As such, a function required from among the above functions is used draw the image data on the Surface 120 directly or after transforming of the image data. However, these functions are only examples and other various functions may be used.

The Surface 120 is the interface which takes the role of input among input and output of the SurfaceTexture 130. The Surface 120 may be dependent on the SurfaceTexture 130 and takes a role of a handle so that the SurfaceTexture 130 may directly access a buffer queue 125. Drawing of the image data on the Surface 120 means that the drawn data is stored in the buffer queue 125. That is, the function provided by the Canvas 110 is used to store the data drawn on the Surface 120 in the buffer queue 125. As the buffer queue 125 is a memory space for storing graphic data defined in Android system, the buffer queue 125 stores various kinds of graphic data to be shown on a screen and transfers the stored data. The Surface 120 is a kind of entry point for applications to access the buffer queue 125.

The SurfaceTexture 130 is an object performing a converting work through which the data drawn on the Surface 120 is converted into a texture data format and the converted data is output to the Texture 140. The SurfaceTexture 130 may not be generated independently and the Texture 140, which is an output part, is firstly generated. Then, an ID of the generated Texture 140 is handed over to the SurfaceTexture 130, thereby generating the SurfaceTexture 130. When a drawing work is performed in the Surface 120, the drawn data is stored in the buffer queue 125. At the completion of the drawing, an event, onFrameAvailable, is generated and the event is transferred to an application (which uses the SurfaceTexture 130). Receiving of the event, onFrameAvailable, in the application means that the data is completely stored in the buffer queue 125. Accordingly, the SurfaceTexture 130 may call a function, updateTexImage and convert the data stored in the buffer queue 125 into texture data.

The Texture 140 may be a space in which the texture data is stored in a GPU memory area. In order to convert or synthesize image data through OpenGL ES, the image data should be firstly converted into texture data, which is an image type used in GPU. Such the converted texture data is stored in the Texture 140.

Hereinafter, converting of image data into texture data at high speed will be sequentially described with reference to FIGS. 1 and 2.

When the application is run or data (images of internal camera or external camera) is to be processed in the application, the application may generate the Canvas 110, the Surface 120, the SurfaceTexture 130, and the Texture 140 from among objects provided by Android system, in operation S210. In operation S210, the Texture 140 is firstly generated and then, the SurfaceTexture 130, the Surface 120, and the Canvas 110 may be sequentially generated. For example, in operation S210, a function, glGenTextures, provided by OpenGL ES is used firstly to generate the Texture 140 and the SurfaceTexture 130 may be generated with reference to the generated Texture 140. Then, the Surface 120 may be generated with reference to the generated SurfaceTexture 130 and the function, IockCanvas, provided by the Surface 120 may be called to return the Canvas 110.

When the objects are generated as described above, the application uses the functions provided by the Canvas 110 and the image data may be drawn on the Surface 120, in operation S220. For example, when the image data is images photographed by an external camera connected to a mobile or by an internal camera of a mobile, the image data may be bitmap images. Also, the application may use the function provided by the Canvas 110 to directly draw the image data on the Surface 120 or to draw the image data on the Surface 120 after converting the image data. As described above, drawing of the image data on the Surface 120 means that the image data is stored in the buffer queue 125. That is, the application may use the function provided by the Canvas 110 to store the image data drawn on the Surface 120 in the buffer queue 125.

Whether the drawn data is completely stored in the buffer queue 125 is determined, in operation S230 and when it is determined that the drawn data is completely stored, the application may use the function provided by the SurfaceTexture 130 to convert the data drawn on the Surface 120 into the texture data and to store the converted data in the Texture 140, in operation S240. That is, the application may convert the data stored in the buffer queue 125 into the texture data and store the converted data in the Texture 140 by using the function provided by the SurfaceTexture 130. For example, when the drawn data is completely stored in the buffer queue 125, in operation S230, an event, onFrameAvailable, is generated. When the event, onFrameAvailable, is generated, the application may use the function updateTexImage, provided by the SurfaceTexture 130 to convert the data drawn on the Surface 120 into the texture data and to store the converted data in the Texture 140.

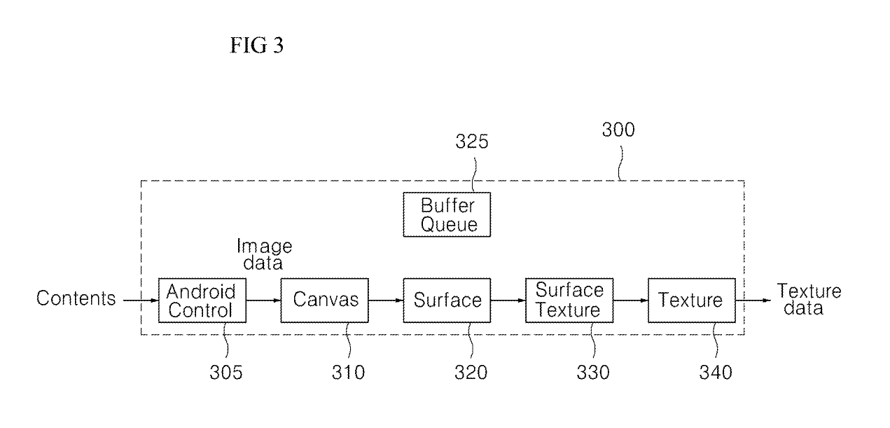

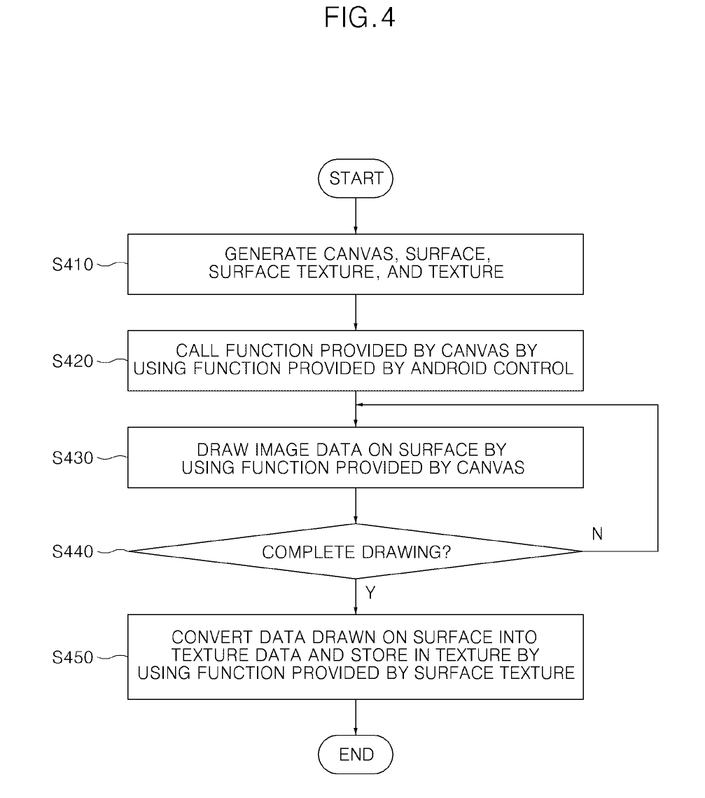

FIG. 3 illustrates objects 300 used in a method of converting data format according to another embodiment of the present invention and FIG. 4 is a flowchart illustrating a method of converting image data into texture data by using the objects 300 of FIG. 3.

Referring to FIGS. 1 through 4, the present invention provides a method of converting image data into texture data in a mobile at high speed, wherein the method is to convert image data provided by an android control 305 into the texture data at high speed. Thus, a Canvas 310, a Surface 320, a SurfaceTexture 330, and a Texture 340 from among objects provided by android system may be used in the present invention. The Canvas 310, the Surface 320, the SurfaceTexture 330, and the Texture 340 illustrated in FIG. 3 are the same objects as the Canvas 110, the Surface 120, the SurfaceTexture 130, and the Texture 140 illustrated in FIG. 1. Accordingly, overlapped description below will be replaced with the description illustrated above with reference to FIGS. 1 and 2.

The android control 305 is a module, which may collect contents (data) from a server (not illustrated) and show the contents, and independently functions to interact with a user when application is run in smart phone. The android control 305 may provide various image data, for example, button images, web images, text images, and progress bar images. For example, when weather-related contents is received from the server, the android control 305 may provide subtitles as image data so that the received contents may be displayed on a screen as a flowing subtitle form. As another example, the android control 305 may provide a button image as image data or image data in which an image is added to the background of the button image. In general, in order to display the image data such as subtitles or images on a screen, the image data is captured and converted into a texture data. Then, the converted texture data is inserted into video and thus such a method may not be used in real-time broadcasting.

Accordingly, such a method may not be used in real-time broadcasting. However, when the method of the present invention described below is used, the image data may be converted into the texture data at high speed and thus, image editing such as insertion of subtitles or images while real-time broadcasting may be available.

Hereinafter, converting of image data into texture data at high speed will be sequentially described with reference to FIGS. 3 and 4.

When the application is run or data (images of internal camera or external camera) is to be processed in the application, the application may generate the Canvas 310, the Surface 320, the SurfaceTexture 330, and the Texture 340 from among objects provided by Android system, in operation S410. In operation S410, as described above with reference to operation S210 of FIG. 2, the Texture 340 is firstly generated and then, the SurfaceTexture 330, the Surface 320, and the Canvas 310 may be sequentially generated. For example, in operation S410, a function, glGenTextures, provided by OpenGL ES is used firstly to generate the Texture 340 and the SurfaceTexture 330 may be generated with reference to the generated Texture 340. Then, the Surface 320 may be generated with reference to the generated SurfaceTexture 330 and the function, lockCanvas, provided by the Surface 320 may be called to return the Canvas 310.

The application may use the functions provided by the android control 305 so as to draw the image data provided by the android control 305 on the Canvas 310 and the Surface 320. That is, the application may call functions provided by the Canvas 310 by using the functions provided by the android control 305, in operation S420. For example, the application may call the functions provided by the Canvas 310 by using the function, onDraw, provided by the android control 305. The functions provided by the Canvas 310 may be at least one of drawArc, drawBitmap, drawCircle, drawColor, drawLine, drawPath, drawPoint, drawRect, and drawText as described above with reference to FIGS. 1 and 2. However, the present invention is not limited thereto and other functions may be used. Then, the function provided by the called Canvas 310 is used to draw the image data on the Surface 320, in operation S430. Drawing of the image data on the Surface 320 means that the image data is stored in a buffer queue 325. That is, the application may use the function provided by the Canvas 310 to store the image data drawn on the Surface 320 in the buffer queue 325.

Whether the drawn data is completely stored in the buffer queue 325 is determined, in operation S440, and when it is determined that the drawn data is completely stored, the application may use the function provided by the SurfaceTexture 330 to convert the data drawn on the Surface 320 into the texture data and to store the converted data in the Texture 340, in operation S450. That is, the application may convert the data stored in the buffer queue 325 into the texture data and store the converted data in the Texture 340 by using the function provided by the SurfaceTexture 330. For example, when the drawn data is completely stored in the buffer queue 325, in operation S440, an event, onFrameAvailable, is generated. When the event, onFrameAvailable, is generated, the application may use the function updateTexImage, provided by the SurfaceTexture 330 to convert the data drawn on the Surface 320 into the texture data and to store the converted data in the Texture 340.

FIG. 4 illustrates that operation S410 is firstly performed and then operation S420 is performed. However, the present invention is not limited to such order and operation S410 may be performed only before the image is drawn on the Surface 320. For example, operations S410 and S420 may be performed in reverse. When an application for real-time broadcasting is run, operation S410 may be performed. When the function, onDraw, is called in the android control 305, operation S410 may be performed. As such, operation S410 may be performed at various stages.

As described above, image data may be converted into texture data at higher speed that that of using a general glTexImage2D function. Accordingly, large data such as cameral images may be processed in real-time.

When the method of converting data format according to an embodiment of the present invention is used, about 20 ms is required to convert 720p images and thus the time of about 5 times faster than that of in using glTexImage2D provided by a general OpenGL ES is required. In general, in order to real-time process large images at resolution of above 720p, high speed of above 30 frames per second is needed. However, when the conventional art is applied, conversion of only about 10 frames per second is available and thus images may not be processed in real-time. When the method of the present invention is applied, high-speed conversion of about 50 frames per second is available and thus large images may be processed in real-time. Also, as in the conventional art, when image data is captured and converted into texture data so as to insert subtitles or images into video, high-speed conversion is not possible as described above and thus images may not be edited in real-time. However, when the method of present invention is applied, image data may be converted into texture data at high-speed so as to insert the converted data into images or to be edited and thus images may be edited in real-time.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of converting data format by which image data may be converted into texture data at high speed in a mobile, the method comprising:
generating a Canvas, a Surface, a SurfaceTexture, and Texture from among objects provided by android system;
drawing the image data on the Surface by using a function provided by the Canvas; and
when the drawing is completed, converting the data drawn on the Surface into the texture data and storing the converted data in the Texture by using a function provided by the SurfaceTexture.

2. The method of claim 1, wherein in the drawing, a function provided by the Canvas
is used to draw the image data on the Surface and to store the drawn data in a buffer queue and in the storing in the Texture, a function provided by the SurfaceTexture is used to convert the data stored in the buffer queue into the texture data and the converted data is stored in the Texture.

3. The method of claim 1, wherein in the drawing, at least one function from among drawArc, drawBitmap, drawCircle, drawColor, drawLine, drawPath, drawPoint, drawRect, drawText provided by the Canvas is used to draw the image data on the Surface.

4. The method of claim 1, wherein the storing in the Texture comprises:
generating an event, onFrameAvailable, when the drawing is completed; and
converting the data drawn on the Surface into the texture data and storing the converted data in the Texture by using a function updateTexImage provided by the SurfaceTexture, when the event, onFrameAvailable, is generated.

5. The method of claim 1, wherein in the generating, the Texture, the SurfaceTexture,
the Surface, and the Canvas are sequentially generated.

6. The method of claim 1, wherein the generating comprises:
generating the Texture by using a function glGenTextures provided by Open Graphic Library for Embedded System (OpenGL ES);
generating the SurfaceTexture with reference to the generated Texture;
generating the Surface with reference to the SurfaceTexture; and
returning the Canvas by calling the function lockCanvas from among the functions provided by the Surface.

7. The method of claim 1, wherein the Texture is a space in which the texture data is stored in a GPU memory area.

8. A method of converting data format by which image data may be converted into texture data at high speed in a mobile, the method comprising:
generating a Canvas, a Surface, a SurfaceTexture, and Texture from among objects provided by android system;
drawing the image data on the Canvas and the Surface by using a function provided by an android control; and
when the drawing is completed, converting the drawn data into the texture data and storing the converted data in the Texture by using a function provided by the SurfaceTexture.

9. The method of claim 8, wherein the drawing comprises:
calling a function provided by the Canvas by using the function provided by the android control; and drawing the image data on the Surface so as to store the drawn data in a buffer queue by using the function provided by the called Canvas, and in the storing in the Texture, a function provided by the SurfaceTexture is used to convert the data stored in the buffer queue into the texture data and the converted data is stored in the Texture.

10. The method of claim 8, wherein the drawing comprises:
calling at least one function from among drawArc, drawBitmap, drawCircle, drawColor, drawLine, drawPath, drawPoint, drawRect, drawText provided by the Canvas by using the function, onDraw, provided by the android control; and
drawing the image data on the Surface by using at least one called function from among the functions provided by the Canvas.

11. The method of claim 8, wherein the storing in the Texture comprises:
generating an event, onFrameAvailable, when the drawing is completed; and
converting the drawn data into the texture data and storing the converted data in the Texture by using a function updateTexImage provided by the SurfaceTexture, when the event, onFrameAvailable, is generated.
